(19) United States
(12) Patent Application Publication
(10) Pub. No.: US 2012/0139442 A1
(43) Pub. Date: Jun. 7, 2012

(54) Mains Dimmable LED Driver Circuits

(75) Inventor: Antonio R. Soleño, Mandaluyong City (PH)

(73) Assignee: Astec International Limited, Kowloon (HK)

(21) Appl. No.: 12/962,213

(22) Filed: Dec. 7, 2010

(51) Int. Cl. H05B 37/02

(52) U.S. Cl. 315/294

(57) ABSTRACT

A method of controlling a dimming level of one or more light emitting diodes (“LEDs”) includes receiving a phase cut dimming signal having a pulse width and frequency, generating a PWM signal having a duty cycle and frequency corresponding to the pulse width and frequency, respectively, of the phase cut dimming signal, and controlling a power converter coupled to the one or more LEDs with the generated PWM signal so that the dimming level of the one or more LEDs is a function of the duty cycle of the generated PWM signal. Example circuits for practicing this method and alternative methods are also disclosed.

### FIELD

The present disclosure relates to mains dimmable LED driver circuits and related methods.

### BACKGROUND

This section provides background information related to the present disclosure which is not necessarily prior art.

Many control circuits for incandescent lighting employ phase cut dimming, where the leading or trailing edge of the AC line voltage is chopped to reduce the RMS voltage provided to the light. By reducing the RMS voltage, the current provided to the light is also reduced, resulting in less output and power consumption. Many traditional light dimmers, including wall dimmers, employ phase cut dimming for controlling the dimming level of incandescent lighting.

### SUMMARY

This section provides a general summary of the disclosure, and is not a comprehensive disclosure of its full scope or all of its features.

According to one aspect of the present disclosure, a method is provided for controlling a dimming level of one or more light emitting diodes (“LEDs”). The method includes receiving a phase cut dimming signal having a pulse width and frequency, generating a PWM signal having a duty cycle and frequency corresponding to the pulse width and frequency, respectively, of the phase cut dimming signal, and controlling a power converter coupled to the one or more LEDs with the generated PWM signal so that the dimming level of the one or more LEDs is a function of the duty cycle of the generated PWM signal.

According to another aspect of the present disclose, a method of controlling a dimming level of one or more LEDs includes receiving a phase cut dimming signal having a pulse width, generating a substantially constant DC signal having an amplitude corresponding to the pulse width of the phase cut dimming signal, and controlling a power converter coupled to the one or more LEDs using the substantially constant DC signal so that the dimming level of the one or more LEDs is a function of the amplitude of the substantially constant DC signal.

According to yet another aspect of this disclosure, a circuit for controlling a dimming level of one or more LEDs includes a rectifier for converting a phase cut AC dimming signal having a pulse width into a rectified phase cut dimming signal having a pulse width and a frequency, a phase detector configured to generate a PWM signal having a duty cycle and frequency corresponding to the pulse width and frequency, respectively, of the rectified phase cut dimming signal, and a power converter responsive to the PWM signal generated by the phase detector for controlling an output current of the power converter.

Further aspects and areas of applicability will become apparent from the description provided herein. It should be understood that various aspects of this disclosure may be implemented individually or in combination with one or more other aspects. It should also be understood that the description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow diagram of a method for controlling the dimming level of one or more LEDs according to one aspect of the present disclosure.

FIG. 2 is a block diagram of a circuit for implementing the method of FIG. 1 according to one example embodiment of the present disclosure.

FIG. 3 is a timing diagram depicting a rectified phase cut dimming signal, a corresponding PWM signal, and a resulting LED current for the circuit of FIG. 2.

FIG. 4 illustrates one preferred construction for the circuit of FIG. 2.

FIG. 5 is a flow diagram of a method for controlling the dimming level of one or more LEDs according to another aspect of the present disclosure.

FIG. 6 is a block diagram of a circuit for implanting the method of FIG. 5 according to another example embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

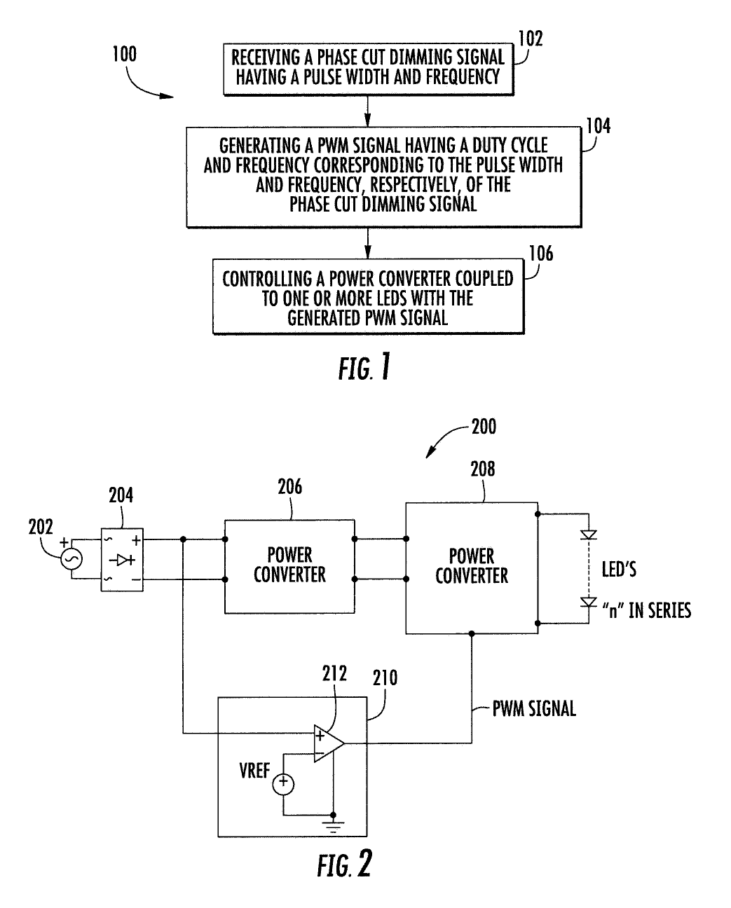

A method of controlling a dimming level of one or more LEDs according to one aspect of the present disclosure is illustrated in FIG. 1 and indicated generally by reference number 100. As shown in FIG. 1, the method 100 includes receiving a phase cut dimming signal having a pulse width and frequency 102, generating a PWM signal having a duty cycle and frequency corresponding to the pulse width and frequency, respectively, of the phase cut dimming signal 104, and controlling a power converter coupled to the one or more LEDs with the generated PWM signal 106. In this manner, the dimming level of the one or more LEDs is controlled as a function of the duty cycle of the generated PWM signal.

As will be apparent from the description below, the power converter coupled to the one or more LEDs may be the only power converter in the LED drive circuit. Alternatively, the power converter may represent one stage of a multi-stage power converter. In that event, the power converter coupled to the one or more LEDs may be energized by another power converter that is energized by the phase cut dimming signal or another suitable power source.

The power converter coupled to the one or more LEDs may be a switching power converter, a linear regulator, or any other suitable power converter. Further, the power converter may be configured to regulate its output current, output voltage or any other suitable parameter to control the average current provided to the one more LEDs.

If the power converter coupled to the one or more LEDs includes a power switch, the generated PWM signal can be used to control the power switch. For example, the power switch may be open when the generated PWM signal is in the low state, and closed when the generated PWM signal is in the high state. Alternatively, if the power converter coupled to the one or more LEDs includes an enable/disable input, the generated PWM signal may be coupled to the enable/disable input. As a result, the power converter may be, e.g., enabled to provide current to the one or more LEDs when the generated PWM signal is in the high state, and disabled to prevent the flow of current to the one or more LEDs when the generated PWM signal is in the low state. In this manner, the average current provided to the one or more LEDs can be controlled to control the brightness level of the LEDs.

The phase cut dimming signal may be received from a wall dimmer (e.g., a user-settable dimming switch mounted on a wall via an electrical box configured to receive a conventional on/off light switch) or any other suitable source. If the received phase cut dimming signal is a full wave AC signal, the method 100 may include rectifying the phase cut dimming signal to generate a rectified phase cut dimming signal. The rectified phase cut dimming signal may have the same pulse width as the input (i.e., non-rectified) dimming signal, and a frequency that is twice the frequency of the input dimming signal.

The PWM signal may be generated in any suitable way. In some embodiments of this disclosure, the PWM signal is generated using a comparator having a first input coupled to the phase cut dimming signal and a second input coupled to a reference voltage. In that event, the frequency of the PWM signal and the frequency of the phase cut dimming signal coupled to the first input may be substantially the same frequency.

Example circuits for performing the method 100 disclosed above will now be described with reference to FIGS. 2-4. It should be understood, however, that the method 100 disclosed above is not limited to the particular embodiments shown in FIGS. 2-4 and can be practiced with a variety of other circuits. Similarly, the example embodiments shown in FIGS. 2-4 are not limited to the method 100 disclosed above and can be used to perform a variety of other methods without departing from the scope of this disclosure.

As shown in FIG. 2, a circuit 200 for controlling a dimming level of one or more LEDs includes an AC source 202 for providing a phase cut dimming signal. The phase cut dimming signal may be, e.g., a full wave AC signal chopped at a zero to 180 degrees phase angle. The AC source 202 may be, e.g., a wall dimmer.

The circuit 200 further includes a rectifier 204, power converters 206, 208, and a phase detector 210. The rectifier 204 may be a bridge or other suitable rectifier for converting the phase cut AC dimming signal provided by the AC source 202 into a rectified phase cut dimming signal. The rectified signal may have the same pulse width and twice the frequency of the full wave phase cut AC dimming signal provided to the rectifier 204. For example, if the full wave dimming signal provided by the AC source 202 has a frequency of 60 Hz, the rectified phase cut dimming signal will have a frequency of 120 Hz.

In the example embodiment of FIG. 2, the rectified phase cut dimming signal is provided to power converter 206 and the phase detector 210. Power converter 206 preferably provides a constant voltage output for energizing power converter 208. Power converter 206 may be any suitable type of AC-DC or DC-DC power converter including, without limitation, a switching power converter having a flyback, boost, buck-boost or other suitable topology. Similarly, power converter 208 may be any suitable power converter including a switching power converter having a buck, boost, buck-boost or other suitable topology, a linear regulator, etc.

The phase detector 210 is configured to generate a PWM signal having a duty cycle and frequency corresponding to the pulse width and frequency, respectively, of the rectified phase cut dimming signal. In the example of FIG. 2, the frequency of the PWM signal generated by the phase detector 210 and the frequency of the rectified phase cut dimming signal are substantially the same frequency.

The power converter 208 is responsive to the PWM signal generated by the phase detector 210 for controlling an output current or voltage of the power converter 208, and thus the current flowing through any LEDs coupled to the output of the power converter 208.

Although two power converters 206, 208 are included in the example embodiment of FIG. 2, it should be understood that more or less converters may be employed in other embodiments. For example, if power converter 206 is eliminated, power converter 208 may be directly coupled to the rectifier 204 and provided with a switch on its output side that is connected in series with the LEDs and controlled by the PWM signal from the phase detector 210. As another alternative, power converter 208 in FIG. 2 can be replaced by multiple power converters connected in a redundant or parallel configuration.

In the example embodiment of FIG. 2, the phase detector 210 includes a comparator 212 having a positive input coupled to receive the rectified phase cut dimming signal and a negative input coupled to a reference voltage VREF. It should be understood, however, that other phase detector configurations may be employed without departing from the scope of this disclosure.

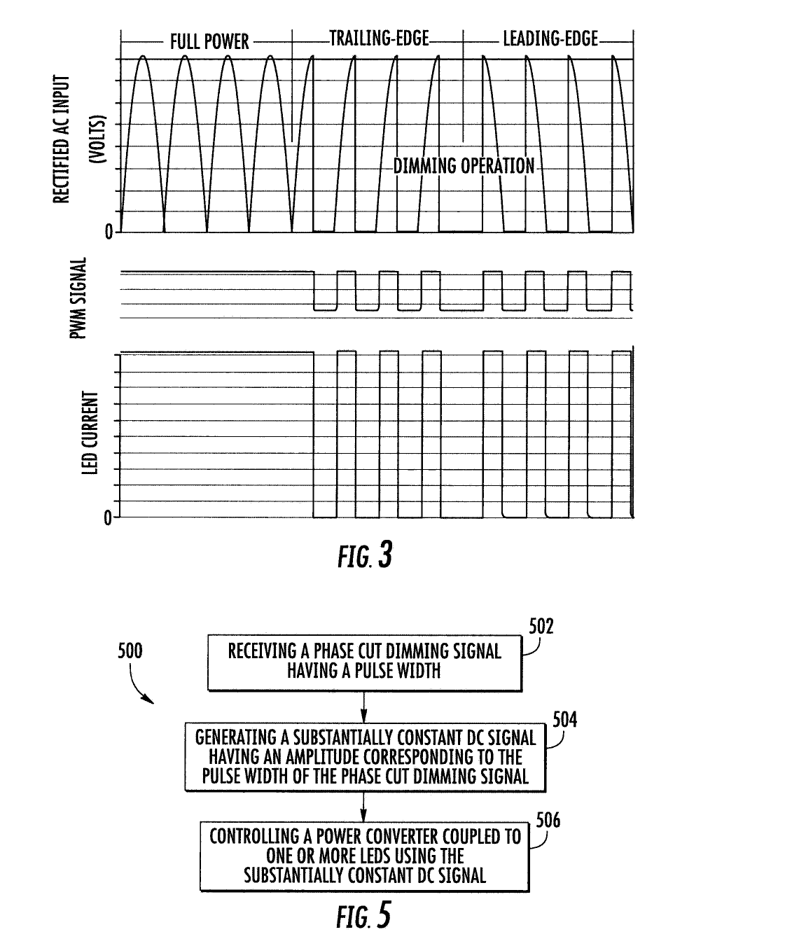

FIG. 3 illustrates several exemplary waveforms for the circuit 200 of FIG. 2. As shown in FIG. 3, when the rectified phase cut dimming signal is unchopped, this represents a full power (i.e., no dimming condition). As a result, the PWM signal generated by the phase detector has a 100% duty cycle, and the current through the LEDs is at the maximum current level. When the rectified phase cut dimming signal is chopped at a 90 degree phase angle (using trailing edge or leading edge phase cutting, both of which are illustrated in FIG. 3), the PWM signal generated by the phase detector has a 50% duty cycle. As a result, the current through the LEDs is pulsed on and off at the 50% duty cycle. This produces an average current through the LEDs that is about half of the maximum current level. As a result, the brightness of the LEDs will be reduced to about half of the maximum brightness level.

Note that if the phase cut dimming signal is chopped at a 45 degree phase angle, the PWM signal generated by the phase detector will have a 75% duty cycle if leading edge phase cutting is employed, and a 25% duty cycle if trailing edge phase cutting is employed.

As shown in FIG. 3, the LED current is essentially a square wave having a duty cycle corresponding to the duty cycle of the PWM signal. Thus, the LED current is essentially on (at a constant DC level) or off at any given time. As a result, there should be LED color changes that can otherwise result from current levels ramping up or down over time. Additionally, when power converter 208 is a switching converter or linear regulator, there is little or no ripple in the LED current (i.e., the current waveform is nearly an ideal square-wave), so there should be no LED color changes due to current ripple. By turning the LED current on and off in response to the PWM signal, the average current through the LEDs can be controlled to control the brightness of the LEDs as desired. Further, the dimming effect is substantially proportional (and preferably linear) to the amount of phase angle chopping provided by the wall dimmer or other AC source 202.

FIG. 4 illustrates one preferred construction of the circuit 200 shown in FIG. 2. In the example of FIG. 4, the power converter 208 includes a buck converter (including transistor Q1, diode D1, inductor L1, and capacitor C2) and a buck controller integrated circuit (IC) 402 having an enable/disable circuit. The PWM signal generated by the phase detector 210 is coupled to the enable/disable input of the buck controller IC 402. Thus, the buck converter is enabled when the PWM signal is high and disabled when the PWM signal is low. The operating frequency of the buck converter IC can be selected as desired for any given application of these teachings. In one preferred embodiment, the operating frequency is between about 75 kHz and about 100 kHz.

The value of the output filter capacitor C2 in FIG. 4 is preferably low so that it cannot hold the DC output voltage for a long period. Therefore, the DC output voltage (and current) waveform substantially matches the PWM signal waveform. In some embodiments, the capacitor C2 is not used.

As an alternative to the example construction shown in FIG. 4, the PWM signal can be coupled directly to the gate of transistor Q1 (with the buck controller IC 402 eliminated) to directly control the on time of the transistor Q1 (which serves as a power switch for the buck converter).

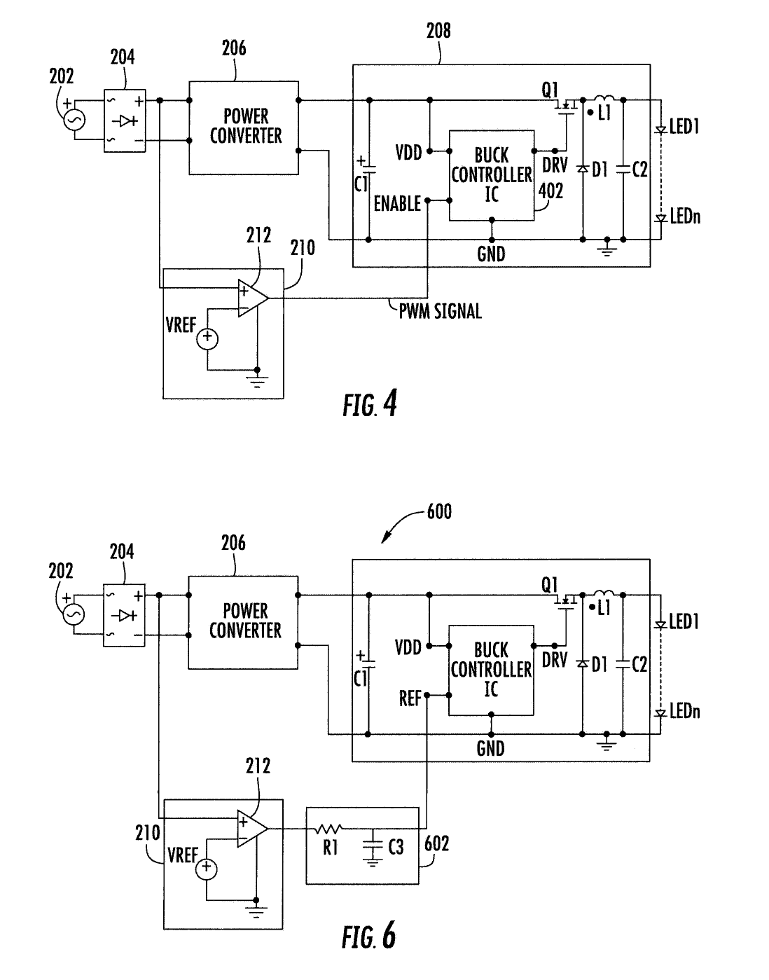

FIG. 5 illustrates a method 500 of controlling a dimming level of one or more LEDs according to another aspect of the present disclosure. As shown in FIG. 5, the method 500 includes receiving a phase cut dimming signal having a pulse width 502, generating a substantially constant DC signal having an amplitude corresponding to the pulse width of the phase cut dimming signal 504, and controlling a power converter coupled to the one or more LEDs using the substantially constant DC signal 506. In this manner, the dimming level of the one or more LEDs is controlled as a function of the amplitude of the substantially constant DC signal.

FIG. 6 illustrates an example circuit 600 suitable for performing the method 500 of FIG. 5. The circuit 600 is similar in many respects to the circuit of FIG. 4. Therefore, a description of the common components (which are identified using the same reference numbers as the circuit of FIG. 4) will not be repeated.

In the circuit 600 of FIG. 6, the PWM signal generated by the phase detector 212 is provided to an averaging circuit 602 for converting the PWM signal having a duty cycle corresponding to the pulse width of the phase cut dimming signal into a substantially constant DC signal having an amplitude corresponding to the pulse width of the phase cut dimming signal. Alternatively, the substantially constant DC signal can be generated directly from the phase cut dimming signal rather than from the PWM signal.

The substantially constant DC signal generated by the averaging circuit 602 is provided to a reference input of the buck controller IC. The buck controller IC is configured to control the transistor switch Q1 based on the amplitude of the constant DC signal. For example, the buck controller may supply a square wave signal to the transistor switch Q1, where the duty cycle of the square wave varies between zero and one hundred percent based on the voltage level of the DC reference signal.

In the particular example shown in FIG. 6, the averaging circuit 602 includes a resistor R1 and a capacitor C3. It should be understood, however, that a variety of other averaging circuits may be employed without departing from the scope of this disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A circuit for controlling a dimming level of one or more LEDs, the circuit comprising:
a rectifier for converting a phase cut AC dimming signal having a pulse width into a rectified phase cut dimming signal having a pulse width and a frequency;
a phase detector configured to generate a PWM signal having a duty cycle and frequency corresponding to the pulse width and frequency, respectively, of the rectified phase cut dimming signal; and
a power converter responsive to the PWM signal generated by the phase detector for controlling an output current or voltage of the power converter.

2. The circuit of claim 1 wherein the frequency of the PWM signal and the frequency of the rectified phase cut dimming signal are substantially the same frequency.

3. The circuit of claim 1 wherein the phase detector includes a comparator having a first input coupled to receive the rectified phase cut dimming signal and a second input coupled to a reference voltage.

4. The circuit of claim 1 wherein the power converter is a first power converter, the circuit further comprising a second power converter coupled between the rectifier and the first power converter.

5. The circuit of claim 4 wherein the second power converter is a switching power converter.

6. The circuit of claim 5 wherein the first power converter is a switching power converter.

7. The circuit of claim 5 wherein the first power converter is a linear regulator.

8. The circuit of claim 4 further comprising a dimmer circuit for supplying the phase cut AC dimming signal.

9. The circuit of claim 8 further comprising one or more LEDs coupled to the power converter for receiving the output current.

10. A method of controlling a dimming level of one or more LEDs, the method comprising:
receiving a phase cut dimming signal having a pulse width and frequency;
generating a PWM signal having a duty cycle and frequency corresponding to the pulse width and frequency, respectively, of the phase cut dimming signal; and
controlling a power converter coupled to the one or more LEDs with the generated PWM signal so that the dimming level of the one or more LEDs is a function of the duty cycle of the generated PWM signal.

11. The method of claim 10 wherein the power converter includes at least one power switch, and wherein controlling includes controlling the at least one power switch with the generated PWM signal.

12. The method of claim 10 wherein the power converter includes an enable/disable input, and wherein controlling includes coupling the generated PWM signal to the enable/disable input.

13. The method of claim 10 further comprising rectifying the phase cut dimming signal.

14. The method of claim 10 wherein the power converter is a first power converter, the method further comprising energizing a second power converter with the phase cut dimming signal, and energizing the first power converter with the second power converter.

15. The method of claim 10 wherein generating includes generating the PWM signal using a comparator having a first input coupled to the phase cut dimming signal and a second input coupled to a reference voltage.

16. The method of claim 10 wherein receiving includes receiving the phase cut dimming signal from a wall dimmer.

17. The method of claim 10 wherein the frequency of the PWM signal and the frequency of the phase cut dimming signal are substantially the same frequency.

18. A method of controlling a dimming level of one or more LEDs, the method comprising:
receiving a phase cut dimming signal having a pulse width;
generating a substantially constant DC signal having an amplitude corresponding to the pulse width of the phase cut dimming signal; and
controlling a power converter coupled to the one or more LEDs using the substantially constant DC signal so that the dimming level of the one or more LEDs is a function of the amplitude of the substantially constant DC signal.

19. The method of claim 18 wherein generating includes generating a PWM signal having a duty cycle corresponding to the pulse width of the phase cut dimming signal, and generating the substantially constant DC signal from the generated PWM signal.
